(19) United States
(12) Patent Application Publication
(10) Pub. No.: US 2018/0060857 A1
(43) Pub. Date: Mar. 1, 2018

(54) Mobile Analytics-Based Identification

(71) Applicant: Wal-Mart Stores, Inc., Bentonville, AR (US)

(72) Inventors: Bruce W. Wilkinson, Rogers, AR (US); Todd D. Mattingly, Bentonville, AR (US); Greg N. Vukin, Bentonville, AR (US)

(21) Appl. No.: 15/689,147

(22) Filed: Aug. 29, 2017

Related U.S. Application Data
(60) Provisional application No. 62/380,806, filed on Aug. 29, 2016.

(51) Int. Cl. G06Q 20/32; G06Q 30/02; H04N 21/422; G06Q 30/06

(52) U.S. Cl. CPC G06Q 20/32; G06Q 30/06; H04N 21/42203; G06Q 30/0267

(57) ABSTRACT

A customer-device interface interacts with customer devices proximal to a retail shopping facility to thereby receive from the customer's device a first unique identifier. A control circuit operably couples to the customer-device interface. The control circuit accesses mobile analytics information regarding locations of customer devices and identifying information for the customer devices comprising a second unique identifier that is different from the first unique identifier. By then also accessing identifying information for customers of the retail shopping facility the control circuit uses the first identifier, the second unique identifier, and the identifying information for customers of the retail shopping facility to correlate the second unique identifier with a particular corresponding customer.

### CROSS-REFERENCE TO RELATED APPLICATION

This application claims the benefit of U.S. Provisional Application No. 62/380,806, filed Aug. 29, 2016, which is incorporated herein by reference in its entirety.

### TECHNICAL FIELD

These teachings relate generally to mobile analytics.

### BACKGROUND

Various branches of mobile analytics are known in the art. As used herein, “mobile analytics” refers to data representing the location and travel over time of mobile communications devices such as cellular telephony devices (including both voice only, data only, and both voice and data compatible devices) and the analysis of such data. Mobile analytics data can be real-time, near-real time (where the data represents circumstances within at least the past, say, ten seconds, thirty seconds, one minute, or the like), and/or historical scenarios.

Mobile analytics data can be captured, for example, by cellular telephony service providers by recording and aggregating as appropriate the service provider's view of their mobile subscribers as those subscribers move and become attached to or otherwise viewed by various cell towers. In many cases a given customer device is visible to a plurality of antenna towers and the location of the customer device can be reliably ascertained by triangulating that location based, for example, on the relative strength of the device's signal at each of the towers. It is also possible that a customer device may have its own native capability of ascertaining its own location, which location the device transmits to the service provider on a push or pull basis as desired to support any of a variety of services (such as, for example, presence-based services).

Mobile analytics data has been analyzed to identify, for example, cellular towers or other network elements that are relatively overloaded and which need to be upgraded or supplemented to continue to assure a quality customer experience. More recently there have been suggestions that mobile analytics data might be useful to retailers and other non-communications service providers to help with their marketing plans. To date, however, such possibilities remain largely without realization.

### BRIEF DESCRIPTION OF THE DRAWINGS

The above needs are at least partially met through provision of the mobile analytics-based identification apparatus and method described in the following detailed description, particularly when studied in conjunction with the drawings, wherein:

FIG. 1 comprises a flow diagram as configured in accordance with various embodiments of these teachings;

FIG. 2 comprises a mobile analytics map as configured in accordance with various embodiments of these teachings;

FIG. 3 comprises a flow diagram as configured in accordance with various embodiments of these teachings;

FIG. 4 comprises a block diagram as configured in accordance with various embodiments of these teachings;

FIG. 5 comprises a flow diagram as configured in accordance with various embodiments of these teachings;

FIG. 6 comprises a flow diagram as configured in accordance with various embodiments of these teachings;

FIG. 7 comprises a schematic representation as configured in accordance with various embodiments of these teachings;

FIG. 8 comprises a graph as configured in accordance with various embodiments of these teachings;

FIG. 9 comprises a flow diagram as configured in accordance with various embodiments of these teachings; and

FIG. 10 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments and by one approach, an enabling apparatus includes a retail shopping facility, a customer-device interface configured and disposed to interact with a customer's device proximal to the retail shopping facility to thereby receive from the customer's device a first unique identifier, and a control circuit that operably couples to the customer-device interface. By one approach, and subject to customer permission, the control circuit serves to access mobile analytics information regarding locations of customer devices and identifying information for the customer devices comprising a second unique identifier that is different from the first unique identifier. By then also accessing identifying information for customers of the retail shopping facility the control circuit uses the first identifier, the second unique identifier, and the identifying information for customers of the retail shopping facility to correlate the second unique identifier with a particular corresponding customer.

So configured, anonymous mobile analytics information can be personalized for at least some of the persons associated with the represented mobile devices. The mobile analytics information, so personalized, can then be leveraged in various ways. By one approach, for example, that information can serve to help identify specific customer-based actions to facilitate.

These teachings are highly flexible in practice. By one approach, for example, the aforementioned customer-device interface comprises a wireless interface such as but not limited to a Wi-Fi access point or a Bluetooth transceiver.

As another example, these teachings will accommodate a variety of different identifiers to serve as the aforementioned first and second unique identifiers. By one approach, for example, the aforementioned first unique identifier can comprise a Media Access Control (MAC) identifier for the corresponding customer's device. The aforementioned second unique identifier, in turn, can comprise, for example, a mobile device Electronic Serial Number (ESN), a mobile device International Mobile Equipment Identity (IMEI) number, or a number (other than a telephone number) assigned by a wireless-communications service provider, to note but a few salient examples in these regards.

The aforementioned identifying information for customers of the retail shopping facility can also be derived in any of a variety of ways. As one example, the identifying information can be gleaned from traceable tender information corresponding to purchases made by consumers at the retail shopping facility. As another example, the identifying information can be obtained from receipt-based information provided directly by customers (via, for example, an app provided by the enterprise that operates the retail shopping facility).

By one approach the mobile analytics information can be used in conjunction with information regarding partiality vectors for customers as well as vectorized characterizations for each of a plurality of products when identifying the aforementioned specific customer-based actions to facilitate.

So configured, these teachings greatly facilitate the value of mobile analytics information and provide a substantive basis for real-world actions that can significantly better daily circumstances for customers of a retail shopping facility.

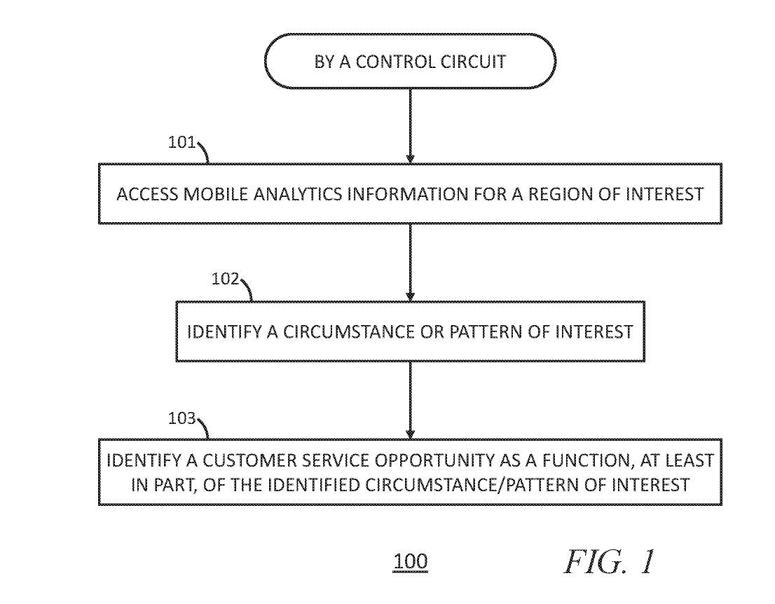

These and other benefits may become clearer upon making a thorough review and study of the following detailed description. Referring now to the drawings, and in particular to FIG. 1, an illustrative process 100 that is compatible with many of these teachings will now be presented. In this description it will be presumed that a control circuit of choice carries out one, some, or all of the described activities that comprise this process 100. Specific examples of such a control circuit are provided further below.

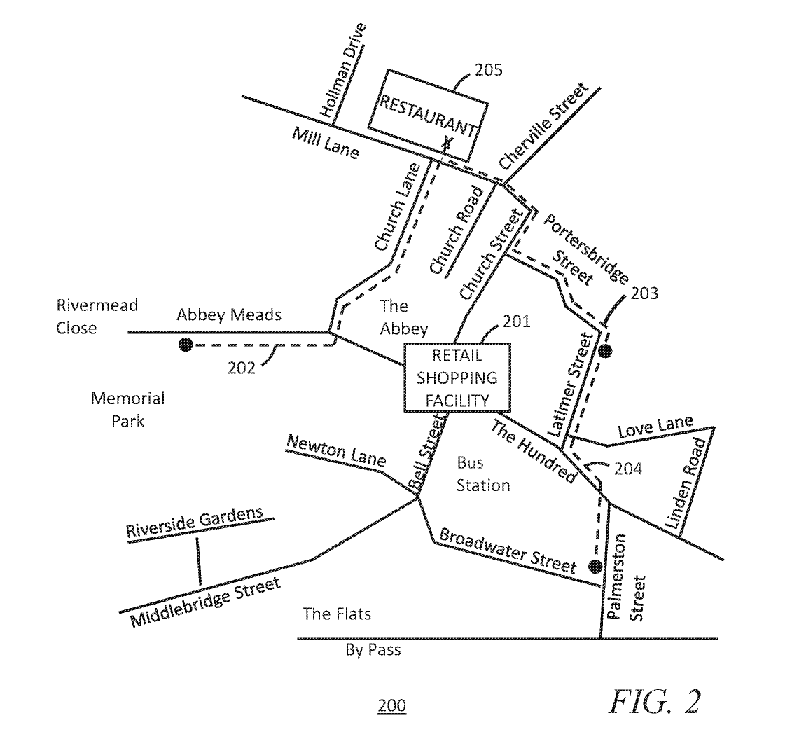

At block 101 this process 100 provides for accessing mobile analytics information for a region of interest. FIG. 2 provides a simple illustrative example in these regards. In particular, FIG. 2 presents an illustration of a street map for a region of interest 200. In this example a retail shopping facility 201 appears at the center of the region of interest 200.

As used herein, the expression “retail shopping facility” will be understood to refer to a facility that comprises a retail sales facility or any other type of bricks-and-mortar (i.e., physical) facility in which products are physically displayed and offered for sale to customers who physically visit the facility. The shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size or format of facility, and may include products from one or more merchants. For example, a facility may be a single store operated by one merchant or may be a collection of stores covering multiple merchants such as a mall.

In this simple example the mobile analytics information illustrates tracking information for three separate mobile devices (such as so-called smart phones). These three separate tracks are denoted by reference numerals 202-204. A dark circle denotes a point of origin and an “X” character denotes a terminus point, both as correspond to a particular journey for a particular mobile device. (It shall be understood that these conventions are used here for the sake of illustration and that any number of graphic approaches can be readily utilized to convey identical or similar information as desired.)

Mobile analytics information can include, inferentially or explicitly, temporal information as well. In the illustration of FIG. 2, for example, the information displayed may represent a particular window of time such as 10 minutes, one hour, or one day (to note but a few possibilities in these regards). If desired, time information can be associated with one or more parts of an individually-displayed track (such as a start time associated with a point of origin or an arrival time associated with a terminus point).

The presentation of such information can be provided to a user on a real-time basis if desired or can be historical in nature if desired (for example, by displaying information from a previous day and without showing information that is more up to the minute). It will also be understood that color or other graphic affectations can be utilized as desired to impart information. For example, different colors can be utilized to disambiguate amongst a plurality of displayed devices. As another example, one color can serve to identify movement during one time of the day (such as during the morning hours) while another color identifies movement during a different time of the day (such as during the afternoon hours). And as yet another example, one color could indicate movement away from a region of interest while another, different color could indicate movement towards a region of interest.

The information presented in FIG. 2 includes only three devices/tracks. Only this limited number of devices are presented here for the sake of simplicity and clarity. In a typical application setting, dozens, hundreds, or even thousands of devices/tracks may be simultaneously presented on such a display/map. Accordingly, some mobile analytics platforms may provide the user with an opportunity to select and sort amongst a plurality of displayed devices/tracks to better facilitate the user's understanding and analysis of the displayed information.

With continued reference to both FIGS. 1 and 2, at block 102 this process 100 provides for identifying within the mobile analytics information a circumstance or pattern of interest. In the simple example of FIG. 2, the circumstance/pattern constitutes identifying restaurants being visited by persons that appear to live or work within the region of interest 200. In this example the three devices/tracks 202-204 all have a point of origin within the region of interest 200 and all include a stop at the same restaurant 205. (Other likely available information regarding other travels by these devices, including where these devices went after visiting the restaurant 205, are not shown here for the sake of clarity.)

At block 103 this process 100 provides for identifying a customer service opportunity as a function, at least in part, of the identified circumstance/pattern of interest. In the present example the circumstance/pattern of interest suggests that persons living within the region of interest 200 (and hence within convenient access to the retail shopping facility 201) enjoy eating meals at this particular restaurant 205. Upon further investigating this particular restaurant 205, it may be determined, for example, that this restaurant 205 offers a particular kind of ethnic food. In that case, this process 100 may provide for stocking the retail shopping facility 201 with food items (including meats, produce, spices, and so forth) that typify (perhaps uniquely) the aforementioned ethnic food but which might not otherwise be ordinarily carried by this retail shopping facility.

These teachings will accommodate a wide variety of circumstances and/or patterns of interest. Examples in these regards include but are not limited to traffic patterns (for example, times when particular streets or intersections are especially heavy with traffic or relatively clear of traffic), apparent gatherings of people at non-retail venues, travel patterns for apparent commuters in the region of interest (including, for example, commuting patterns driven in part by the availability or unavailability of work-time flexibility such that employees leave their homes for work over wider or narrower time windows), residential patterns (for example, patterns regarding where people live relative to their employer), traffic patterns regarding people who are likely sharing a same road at the same time, travel patterns of students traveling between school and home, and so forth.

Similarly, these teachings will also accommodate a wide variety of resultant customer service opportunities. Examples in these regards include but are not limited to items to be offered as complementary samples at a retail shopping facility or at another location suggested by the mobile analytics information, items to be offered at food trucks or other mobile offerings platforms, sponsorship opportunities for the retail shopping facility, traveler-dependent content to be displayed via roadside electronic billboards, and so forth.

In the examples above the mobile analytics information presumably provides no information that the retail shopping facility can utilize to directly identify a user or other entity that corresponds to any of the tracked mobile devices. Notwithstanding the anonymous nature of the mobile analytics information, as shown above that information can nevertheless provide many helpful insights and clues to improve product and service offerings by such a retail shopping facility.

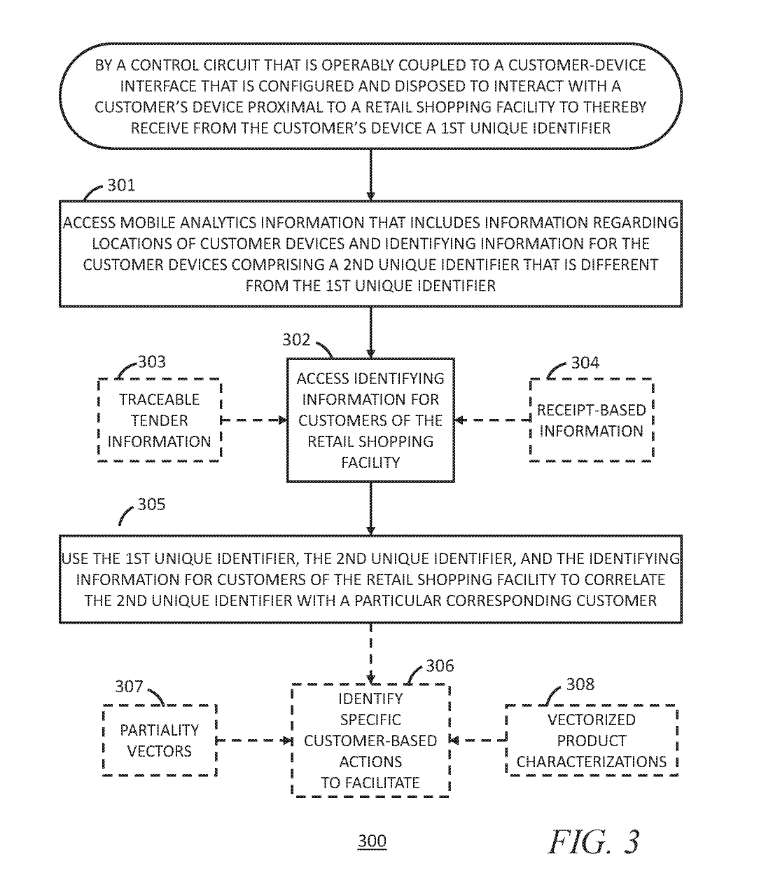

Referring now to FIG. 3, these teachings also contemplate an approach that permits anonymous mobile analytics information to be employed, at least in part, to identify a particular device user and to use that identification to greatly personalize the customer service opportunity that may be provided to such a customer. In a typical application setting this personalization is undertaken subject to the permission and possible other stipulations and requirements of the customer.

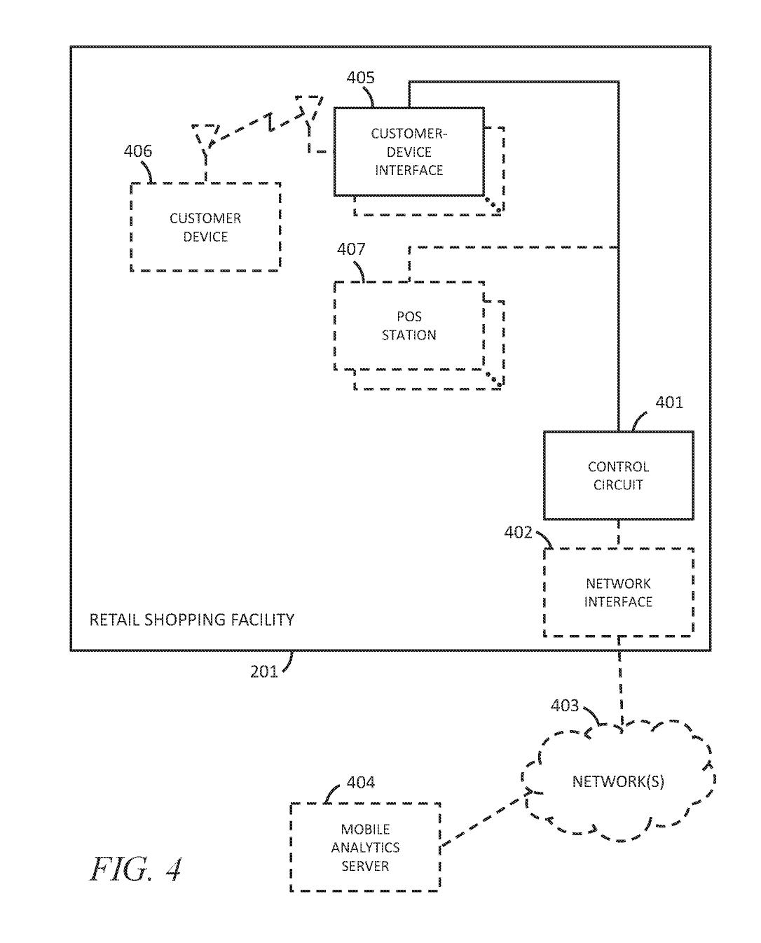

In particular, FIG. 3 presents a process 300 that can be carried out by a control circuit that operably couples to a customer-device interface that interacts with a customer's device proximal to a retail shopping facility to thereby receive a unique identifier from the customer's device. FIG. 4 provides an illustrative example in this regard.

In this example a retail shopping facility 201 includes a control circuit 401. Being a “circuit,” this control circuit 401 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 401 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 401 is configured (for example, by using corresponding programming as will be well understood by those skilled in the art) to carry out one or more of the steps, actions, and/or functions described herein.

By one optional approach the control circuit 401 operably couples to a memory (not shown). This memory may be integral to the control circuit 401 or can be physically discrete (in whole or in part) from the control circuit 401 as desired. This memory can also be local with respect to the control circuit 401 (where, for example, both share a common circuit board, chassis, power supply, and/or housing) or can be partially or wholly remote with respect to the control circuit 401 (where, for example, the memory is physically located in another facility, metropolitan area, or even country as compared to the control circuit 401).

This memory can serve, for example, to non-transitorily store computer instructions that, when executed by the control circuit 401, cause the control circuit 401 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

By one approach the control circuit 401 optionally operably couples to a network interface 402. So configured the control circuit 401 can communicate with other network elements (such as but not limited to a mobile analytics server 404 that provides mobile analytics information per these teachings) using one or more intervening networks via the network interface 402. Network interfaces, including both wireless and non-wireless platforms, are well understood in the art and require no particular elaboration here. These teachings will support using any of a wide variety of networks including but not limited to the Internet (i.e., the global network of interconnected computer networks that use the Internet protocol suite (TCP/IP)).

In this illustrative example the control circuit 401 operably couples to at least one customer-device interface 405. The customer-device interface can comprise, by one approach, a wireless interface such as but not limited to a Wi-Fi access point and/or a Bluetooth transceiver. (As used herein “Wi-Fi” will be understood to refer to a technology that allows electronic devices to connect to a wireless Local Area Network (LAN) (generally using the 2.4 gigahertz and 5 gigahertz radio bands). More particularly, “Wi-Fi” refers to any Wireless Local Area Network (WLAN) product based on interoperability consistent with the Institute of Electrical and Electronics Engineers' (IEEE) 802.11 standards. Also as used herein, “Bluetooth” will be understood to refer to a wireless communications standard managed by the Bluetooth Special Interest Group. The Bluetooth standard makes use of frequency-hopping spread spectrum techniques and typically provides for only a very short range wireless connection (typically offering a range of only about ten meters in many common application settings). This standard comprises a packet-based approach that relies upon a so-called master-slave paradigm where a master device can support only a limited (plural) number of subservient devices.)

The customer-device interface 405 is configured and disposed to interact with a customer's device 406 proximal to the retail shopping facility 201. In a typical application setting this interaction will constitute a wireless communication of information. As used herein, the customer's device 406 is “proximal” to the retail shopping facility 201 when the customer's device 406 is within the retail shopping facility 201 and/or when the customer's device 406 is within a short distance of the retail shopping facility 201 (such as, for example, 1 meter, 5 meters, 10 meters, 30 meters, or some other minimal distance of choice).

As already noted above, the customer-device interface serves, at least in part, to receive from the customer's device 406 a first unique identifier. Generally speaking this first unique identifier does not directly identify the user of the customer's device 406. For example, the first unique identifier is not the full or abridged name of the customer nor a full or abridged name of a personally-selected customer avatar.

Instead, and by one approach, the first unique identifier comprises a Media Access Control (MAC) address for the customer's device 406. A MAC address of a computer is a unique identifier assigned to network interfaces for communications at the data link layer of a network segment. MAC addresses are used as a network address for many IEEE 802 network technologies, including Ethernet, Wi-Fi, and often Bluetooth. Logically, MAC addresses are used in the media access control protocol sublayer of the OSI reference model. MAC addresses are most often assigned by the manufacturer of a Network Interface Controller (NIC) and are stored in its hardware, such as the card's read-only memory or some other firmware mechanism. If assigned by the manufacturer, a MAC address usually encodes the manufacturer's registered identification number and may be referred to as the burned-in address. It may also be known as an Ethernet hardware address, hardware address, or physical address. MAC addresses are formed according to the rules of one of three numbering name spaces managed by the Institute of Electrical and Electronics Engineers, (i.e., MAC-48, EUI-48, and EUI-64).

As one illustrative example, the customer device 406 may comprise a so-called smart phone having Wi-Fi and/or Bluetooth conductivity capabilities. When the customer device 406 is within a range of the customer-device interface 405, these two elements may automatically communicate with one another during which communication the customer device 406 provides its MAC address to the customer-device interface 405. The customer-device interface 405 then supplies that MAC address to the control circuit 401.

As illustrated in FIG. 4, the retail shopping facility 201 may also optionally include one or more so-called point of sale (POS) stations 407. A POS station 407 is where a customer completes a retail transaction. Typically, the retailer calculates the amount owed by the customer and indicates that amount to the customer. The POS station 407 also serves as the point where the customer pays the retailer in exchange for goods or after provision of a service. After receiving payment, the retailer may issue a receipt (hard copy or otherwise) for the transaction. The POS station 407 may be directly attended by an associate of the retail shopping facility 201 or may be partially or wholly automated.

In many cases the customer's payment includes traceable tender information such as the customer's name or an identifier that can be readily and directly linked to the customer's name. In this example the control circuit 401 is configured to access at least some traceable tender information from a POS station 407 corresponding to purchases made by customers at the retail shopping facility 201.

With continued reference to FIGS. 3 and 4, this process 300 provides, at block 301, for having the control circuit 401 access mobile analytics information (sourced, for example, by the aforementioned mobile analytics server 404). This mobile analytics information includes information regarding locations of customer devices and identifying information for the customer devices comprising a second unique identifier that is different from the aforementioned first unique identifier.

The received information regarding locations of customer devices can vary as described above. By one approach the information provides mapped tracking information for a plurality of customer devices within some report region over some relevant period of time. Different colors can be used to parse the informational content and graphic icons can be utilized to indicate times, events, and other parameters of interest as desired.

Generally speaking, those who provide mobile analytics information do not provide that information in conjunction with any content that specifically identifies a particular user. For example, the provided content typically lacks user names or other user monikers, telephone numbers, email addresses, or the like. On the other hand, mobile analytics information often includes an identifier for each track and/or displayed device in order to help the analyst disambiguate the depicted information. The second unique identifier may therefore comprise, for example, a mobile device Electronic Serial Number (ESN), a mobile device International Mobile Equipment Identity (IMEI) number, or a (possibly random) number/identifier assigned by a wireless-communications service provider and/or the party providing the mobile analytics information.

It may be noted that the second unique identifier may be displayed on a map that presents the mobile analytics tracking data. By another approach the second unique identifier may be revealed by effecting some selection action with respect to a particular track (for example, double-clicking on a particular track). The present teachings are relatively insensitive to how the second unique identifiers are included with the received mobile analytics information.

At block 302 the control circuit 401 accesses identifying information for customers of the retail shopping facility 201. By one optional approach this identifying information may be obtained from traceable content information 303 that corresponds to purchases made by the customers at the retail shopping facility 201 as captured by, for example, the aforementioned POS station 407. For example, a customer's name is typically included with other information presented at the POS station 407 when paying for a purchase using a credit card or a debit card.

By another optional approach, in lieu of the foregoing or in combination therewith, the identifying information may be received along with other receipt-based information 304 that is provided directly by customers. Such receipt-based information 304 can also serve to correlate purchases made by customers at the retail shopping facility 201 with their corresponding identifying customer information. A customer can be enabled to directly provide such information using, for example, a smart phone app provided or otherwise supported by the enterprise that operates the retail sales facility 201. Such an app can provide an opportunity for the customer to maintain a virtual record of their shopping or can, for example, serve as a way for the customer to have the enterprise check and ensure that prices paid by the customer meet some pricing guarantee of the enterprise.

At block 305, the control circuit 401 uses the first unique identifier, the second unique identifier, and the identifying information for customers of the retail shopping facility 201 to statistically (or, perhaps more accurately, by the process of elimination) correlate one of the second unique identifiers with a particular corresponding customer.

More specifically, for a given block of time the control circuit 401 knows which customer devices are likely at the retail shopping facility 201 by referencing the mobile analytics information. In particular, the control circuit 401 knows particular second unique identifiers that have arrived at the retail shopping facility 201. For that same block of time the control circuit 401 also knows which customer devices have presented the aforementioned first unique identifier at the retail shopping facility 201. And lastly, and again for that same block of time, the control circuit 401 further knows the names of (at least many) specific customers who made purchases at the retail shopping facility 201.

The control circuit 401 uses the foregoing information to accurately correlate a particular customer to a particular anonymized mobile device identifier as used with the mobile analytics information, in many cases, as a result of only a single customer visit to the retail shopping facility 201. In other cases there may be sufficient customer/device activity to create some ambiguity in these regards after only a single customer visit. In that case, the ambiguity can be relieved and an accurate correlation made after X number of additional visits by a particular customer to the retail shopping facility 201 (where X is an integer of 1 or greater).

So configured, and particularly over time, the control circuit 401 can personalize the previously anonymized mobile analytics information to thereby associate particular customers with particular identifiers for various mobile devices/tracks. Accordingly, the control circuit 401 can utilize that personalization when analyzing later-received mobile analytics information in various ways to benefit the identified customers.

Optional block 306 provides some illustrative examples in these regards. Here, the control circuit 401 uses the now-personalized mobile analytics information to identify specific customer-based actions to facilitate. In particular, and as one example in these regards, the control circuit 401 can employ partiality vectors 307 that correspond to the identified customer and vectorized product characterizations 308 in combination with information regarding where the now-identified customer travels, visits, shops, and otherwise engages themselves to identify particular products and/or services to make available to the customer.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

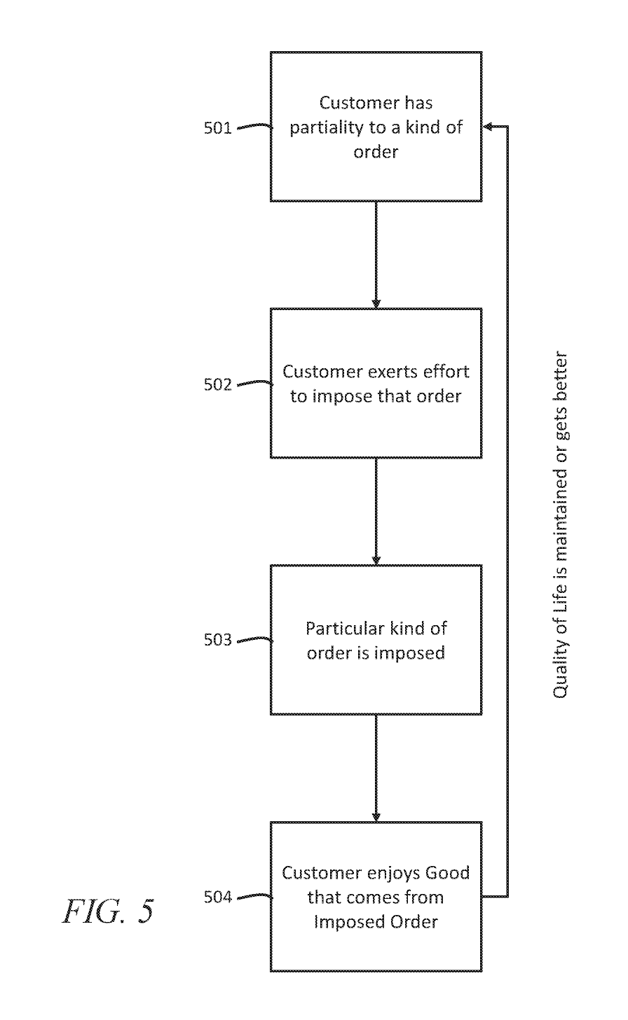

FIG. 5 provides a simple illustrative example in these regards. At block 501 it is understood that a particular person has a partiality (to a greater or lesser extent) to a particular kind of order. At block 502 that person willingly exerts effort to impose that order to thereby, at block 503, achieve an arrangement to which they are partial. And at block 504, this person appreciates the “good” that comes from successfully imposing the order to which they are partial, in effect establishing a positive feedback loop.

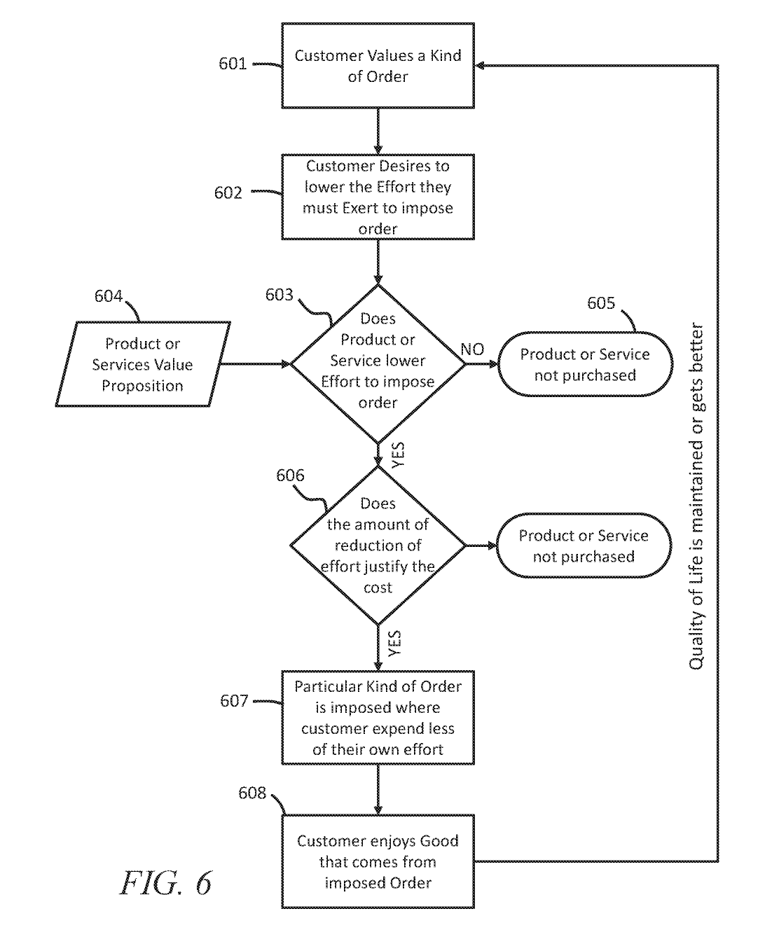

Understanding these partialities to particular kinds of order can be helpful to understanding how receptive a particular person may be to purchasing a given product or service. FIG. 6 provides a simple illustrative example in these regards. At block 601 it is understood that a particular person values a particular kind of order. At block 602 it is understood (or at least presumed) that this person wishes to lower the effort (or is at least receptive to lowering the effort) that they must personally exert to impose that order. At decision block 603 (and with access to information 604 regarding relevant products and or services) a determination can be made whether a particular product or service lowers the effort required by this person to impose the desired order. When such is not the case, it can be concluded that the person will not likely purchase such a product/service 605 (presuming better choices are available).

When the product or service does lower the effort required to impose the desired order, however, at block 606 a determination can be made as to whether the amount of the reduction of effort justifies the cost of purchasing and/or using the proffered product/service. If the cost does not justify the reduction of effort, it can again be concluded that the person will not likely purchase such a product/service 605. When the reduction of effort does justify the cost, however, this person may be presumed to want to purchase the product/service and thereby achieve the desired order (or at least an improvement with respect to that order) with less expenditure of their own personal effort (block 607) and thereby achieve, at block 608, corresponding enjoyment or appreciation of that result.

To facilitate such an analysis, the applicant has determined that factors pertaining to a person's partialities can be quantified and otherwise represented as corresponding vectors. These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

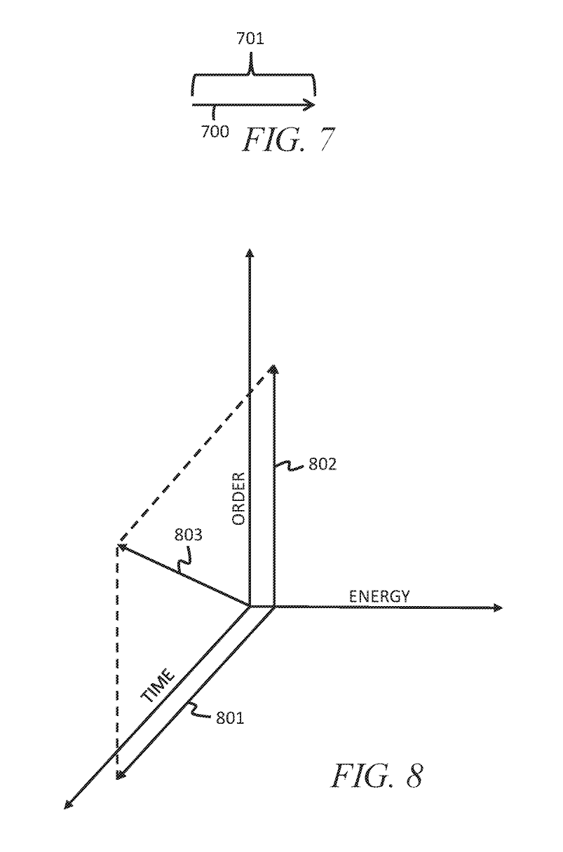

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. In particular, and referring as well to FIG. 7, the vector's 700 direction represents order imposed upon material space-time by a particular partiality (such as a particular value) while the vector's magnitude 701 represents the magnitude of the strength of the belief in the good that comes from that imposed order (which belief, in turn, can be a function, relatively speaking, of the extent to which the order for this particular partiality is enabled and/or achieved).

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

FIG. 8 presents a space graph that illustrates many of the foregoing points. A first vector 801 represents the time required to make such a wristwatch while a second vector 802 represents the order associated with such a device (in this case, that order essentially represents the skill of the craftsman). These two vectors 801 and 802 in turn sum to form a third vector 803 that constitutes a value vector for this wristwatch. This value vector 803, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude of a partiality vector for a person can represent, directly or indirectly, a corresponding effort the person is willing to exert to pursue that partiality. There are various ways by which that magnitude can be determined. As but one non-limiting example in these regards, the magnitude V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

By forming reliable partiality vectors for various individuals and corresponding partiality vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value.

By one approach there can be hundreds or even thousands of identified partialities. In this case, if desired, each product/service of interest can be assessed with respect to each and every one of these partialities and a corresponding partiality vector formed to thereby a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere. Negative magnitudes would represent the introduction of carbon emissions (for example, as a result of manufacturing the product, transporting the product, and/or using the product)

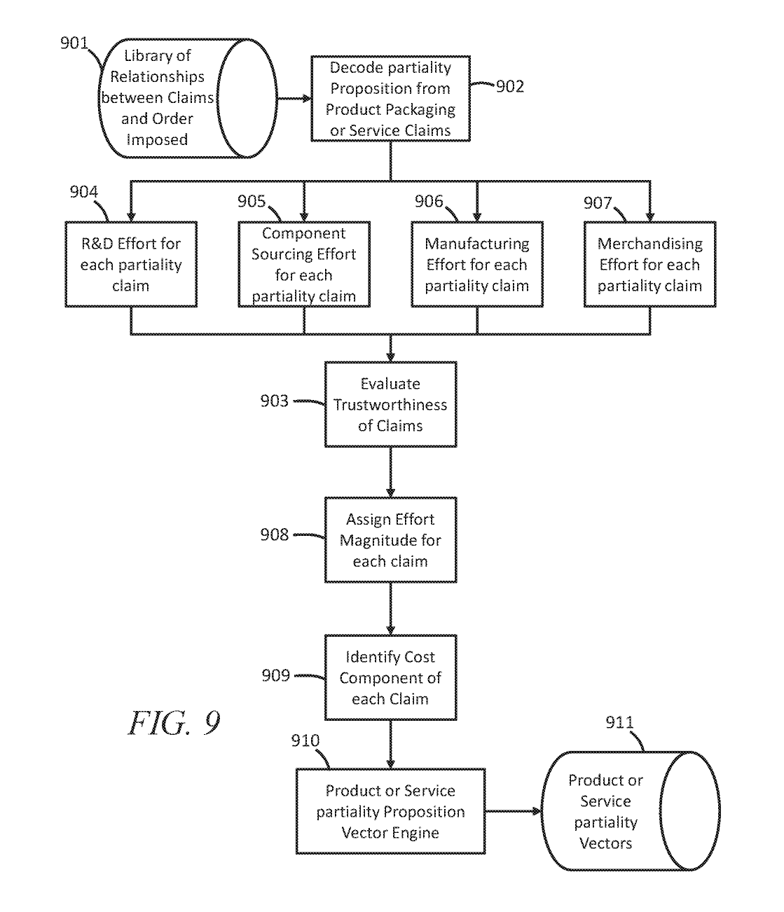

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

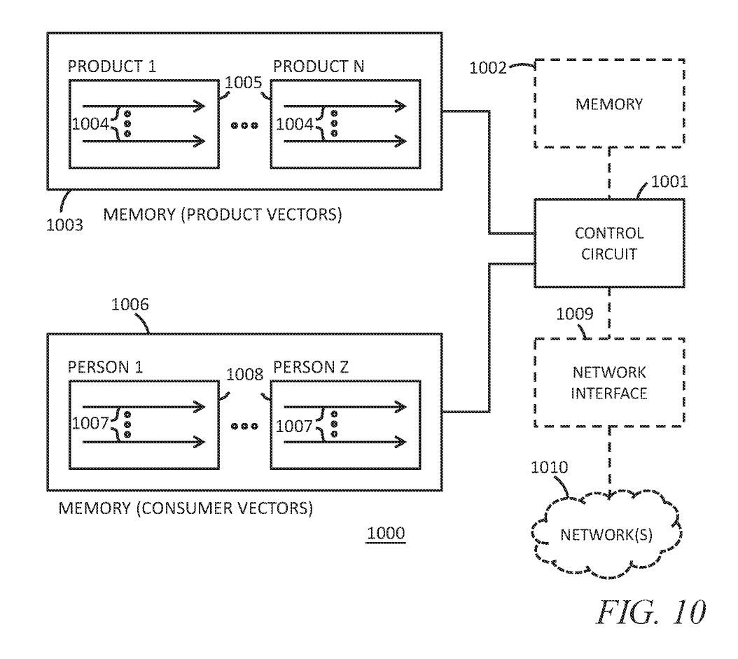

FIG. 10 presents an illustrative apparatus 1000 for conducting, containing, and utilizing the foregoing content and capabilities. In this particular example, the enabling apparatus 1000 includes a control circuit 1001. This control circuit 1001 can be configured the same as the aforementioned control circuit 401 and can even be the aforementioned control circuit 401 if desired.

By one optional approach the control circuit 1001 operably couples to a memory 1002. This memory 1002 may be integral to the control circuit 1001 or can be physically discrete (in whole or in part) from the control circuit 1001 as desired. This memory 1002 can also be local with respect to the control circuit 1001 (where, for example, both share a common circuit board, chassis, power supply, and/or housing) or can be partially or wholly remote with respect to the control circuit 1001 (where, for example, the memory 1002 is physically located in another facility, metropolitan area, or even country as compared to the control circuit 1001).

This memory 1002 can serve, for example, to non-transitorily store the computer instructions that, when executed by the control circuit 1001, cause the control circuit 1001 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1002 or, as illustrated, in a separate memory 1003 are the vectorized characterizations 1004 for each of a plurality of products 1005 (represented here by a first product through an Nth product where “N” is an integer greater than “1”). In addition, and again either stored in this memory 1002 or, as illustrated, in a separate memory 1006 are the vectorized characterizations 1007 for each of a plurality of individual persons 1008 (represented here by a first person through a Zth person wherein “Z” is also an integer greater than “1”).

In this example the control circuit 1001 also operably couples to a network interface 1009. So configured the control circuit 1001 can communicate with other elements (both within the apparatus 1000 and external thereto) via the network interface 1009. Network interfaces, including both wireless and non-wireless platforms, are well understood in the art and require no particular elaboration here. This network interface 1009 can compatibly communicate via whatever network or networks 1110 may be appropriate to suit the particular needs of a given application setting. Both communication networks and network interfaces are well understood areas of prior art endeavor and therefore no further elaboration will be provided here in those regards for the sake of brevity.

As already suggested above, these approaches provide powerful ways for identifying products and/or services that a given person, or a given group of persons, may likely wish to buy to the exclusion of other options. As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criteria are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

Accordingly, the aforementioned personalized mobile analytics information can be leveraged to help further particularize partiality vectors for a corresponding customers and can further help to develop specific customer-based actions to facilitate based upon the customer's historical and real-time locations (and the behaviors and activities suggested by those locations) and their corresponding partiality vectors.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
at least a first retail shopping facility;
a customer-device interface configured and disposed to interact with a customer's device proximal to the first retail shopping facility to thereby receive from the customer's device a first unique identifier;
a control circuit operably coupled to the customer-device interface and configured to:
access mobile analytics information that includes information regarding locations of customer devices and identifying information for the customer devices comprising a second unique identifier that is different from the first unique identifier;
access identifying information for customers of the first retail shopping facility;
use the first unique identifier, the second unique identifier, and the identifying information for customers of the first retail shopping facility to correlate the second unique identifier with a particular corresponding customer.

2. The apparatus of claim 1 wherein the customer-device interface comprises a wireless interface.

3. The apparatus of claim 2 wherein the wireless interface comprises at least one of a Wi-Fi access point and a Bluetooth transceiver.

4. The apparatus of claim 2 wherein the first unique identifier comprises a Media Access Control (MAC) address for the corresponding customer's device.

5. The apparatus of claim 1 wherein the second unique identifier comprises at least one of:
a mobile device Electronic Serial Number (ESN);
a mobile device International Mobile Equipment Identity (IMEI) number;
a number assigned by a wireless-communications service provider.

6. The apparatus of claim 1 wherein the control circuit is configured to access the identifying information for customers of the first retail shopping facility by, at least in part, accessing traceable tender information corresponding to purchases made by the customers at the first retail shopping facility.

7. The apparatus of claim 1 wherein the control circuit is configured to access the identifying information for customers of the first retail shopping facility by, at least in part, accessing receipt-based information provided directly by the customers that correlates purchases made by the customers at the first retail shopping facility with identifying customer information.

8. The apparatus of claim 1 wherein the control circuit is further configured to:
access information including a plurality of partiality vectors for customers that are correlated with the second unique identifiers.

9. The apparatus of claim 8 wherein the control circuit is further configured to:
use the plurality of partiality vectors in combination with the mobile analytics information to identify specific customer-based actions to facilitate.

10. The apparatus of claim 9 wherein the control circuit is further configured to:
access vectorized characterizations for each of a plurality of products, wherein each of the vectorized characterizations indicates a measure regarding an extent to which a corresponding one of the products accords with a corresponding one of the plurality of partiality vectors;
also use the vectorized characterizations when identifying the specific customer-based actions to facilitate.

11. A method comprising:
by a control circuit that is operably coupled to a customer-device interface that is configured and disposed to interact with a customer's device proximal to a first retail shopping facility to thereby receive from the customer's device a first unique identifier:
accessing mobile analytics information that includes information regarding locations of customer devices and identifying information for the customer devices comprising a second unique identifier that is different from the first unique identifier;
accessing identifying information for customers of the first retail shopping facility;
using the first unique identifier, the second unique identifier, and the identifying information for customers of the first retail shopping facility to correlate the second unique identifier with a particular corresponding customer.

12. The method of claim 11 wherein the customer-device interface comprises a wireless interface.

13. The method of claim 12 wherein the wireless interface comprises at least one of a Wi-Fi access point and a Bluetooth transceiver.

14. The method of claim 12 wherein the first unique identifier comprises a Media Access Control (MAC) address for the corresponding customer's device.

15. The method of claim 11 wherein the second unique identifier comprises at least one of:
a mobile device Electronic Serial Number (ESN);
a mobile device International Mobile Equipment Identity (IMEI) number;
a number assigned by a wireless-communications service provider.

16. The method of claim 11 wherein accessing the identifying information for customers of the first retail shopping facility comprises, at least in part, accessing traceable tender information corresponding to purchases made by the customers at the first retail shopping facility.

17. The method of claim 11 wherein accessing the identifying information for customers of the first retail shopping facility comprises, at least in part, accessing receipt-based information provided directly by the customers that correlates purchases made by the customers at the first retail shopping facility with identifying customer information.

18. The method of claim 11 further comprising:
accessing information including a plurality of partiality vectors for customers that are correlated with the second unique identifiers.

19. The method of claim 18 further comprising:
using the plurality of partiality vectors in combination with the mobile analytics information to identify specific customer-based actions to facilitate.

20. The method of claim 19 further comprising:
accessing vectorized characterizations for each of a plurality of products, wherein each of the vectorized characterizations indicates a measure regarding an extent to which a corresponding one of the products accords with a corresponding one of the plurality of partiality vectors;
and wherein using the plurality of partiality vectors in combination with the mobile analytics information to identify specific customer-based actions to facilitate further comprises also using the vectorized characterizations when identifying the specific customer-based actions to facilitate.
